(19) United States
(12) Patent Application Publication
(10) Pub. No.: US 2023/0279836 A1
(43) Pub. Date: Sep. 7, 2023

(54) Grid Decoupled Wind Powered Hydrogen Generation and Storage

(71) Applicant: Keith Charles Avery, Waialua, HI (US)

(72) Inventor: Keith Charles Avery, Waialua, HI (US)

(21) Appl. No.: 18/115,677

(22) Filed: Feb. 28, 2023

Related U.S. Application Data
(60) Provisional application No. 63/265,923, filed on Mar. 1, 2022.

(51) Int. Cl. F03D 7/02; F03D 9/19; F03D 9/25

(52) U.S. Cl. CPC F03D 7/026; F03D 7/0224; F03D 9/19; F03D 9/25; F03D 7/0204; F05B 2260/42; F05B 2220/706

(57) ABSTRACT

A wind powered hydrogen generator with storage that is decoupled from an electric grid. A start-up fuel cell provides power to the generator to energize the generator's field coils, to the pitch adjustable blades to adjust pitch of the blades to maintain rotation rate of the rotor, and to power the yawing motor. Electrolyzers are stacked in the tower to generate hydrogen, which is stored in hydrogen impermeable piping mounted on the tower to receive hydrogen for storage and to provide hydrogen to the start-up fuel cell. The invention can be sited in locations having wind speeds within the operating range of wind speeds, regardless of whether connection can be made to the electric grid.

This application claims the benefit of U.S. provisional patent application 63/265,923 filed Mar. 1, 2022, incorporated herein by reference.

### TECHNICAL FIELD

This invention relates to generating hydrogen from wind without connection to an electrical grid, and storage of the generated hydrogen, converting the intermittent energy of wind into energy that can be stored and made available on demand, referred to as firm energy.

### BACKGROUND ART

The subject technology is generally related to the production of green hydrogen energy at commercial scale and the storage of the end product, Renewable Hydrogen Gas (RHG) to use as gaseous hydrogen or in the generation of electricity. Individually the technology components exist and are commercially available at the MW size. The components have never been put together as one mechanism or built to stand upright inside the wind turbine. It is consolidating the various components of the whole integrated and decoupled design that makes the Zero Emissions US (ZEUS) hydrogen generator (ZGen) specifically dedicated to creating ZGas and storing it on-board the wind turbine in FRP pipe that ultimately allows utility transmission disconnection. ZGen permits, “as available” wind energy to provide “base load” or “firm power” on demand from on or off-site MW size fuel cells, autonomously.

To produce hydrogen, it must be separated from the other elements in the molecules where it occurs. There are many different sources of hydrogen and ways for producing it for use as a fuel. The two most common methods for producing hydrogen are Steam-Methane Reformation and electrolysis (splitting water with electricity). Researchers are exploring other hydrogen production methods or pathways including: Using microbes that use light to make hydrogen, converting biomass into gas or liquids and separating the hydrogen, using solar energy technologies to split hydrogen from water molecules.

Steam Methane Reformation (SMR) is a chemical process used in the gas manufacturing industry to produce hydrogen on a large scale. SMR currently accounts for nearly all commercially produced hydrogen in the United States and the world. Commercial hydrogen producers and petroleum refineries use steam-methane reforming to separate hydrogen atoms from carbon atoms in methane (CH₄). In SMR, high-temperature steam (1,300° F. to 1,800° F.) under 3-25 bar pressure (1 bar=14.5 pounds per square inch) reacts with methane in the presence of a catalyst to produce hydrogen, carbon monoxide, and a relatively small amount of carbon dioxide (CO2).

Natural gas is the main methane source for hydrogen production by industrial facilities and petroleum refineries. Landfill gas/biogas, which may be called biomethane or renewable natural gas, is a source of hydrogen for several fuel cell power plants in the United States. Biofuels and petroleum fuels are also potential hydrogen sources.

Electrolysis is a process that splits hydrogen from water using an electric current. On a large, commercial scale, the process may be referred to as power-to-gas, where power is electricity and hydrogen is gas. Electrolysis itself does not produce any byproducts or emissions other than hydrogen and oxygen. The electricity for electrolysis can come from renewable sources, nuclear energy, or fossil fuels. If the electricity for electrolysis is produced from fossil fuel (coal, natural gas, and petroleum) or biomass combustion, then the related environmental effects and CO2 emissions are indirectly associated with that hydrogen.

Hydrogen producers, marketers, government agencies, and other organizations might categorize or define hydrogen according to the energy sources for its production, and they use a color code to categorize hydrogen. For example, hydrogen produced using renewable energy might be referred to as renewable hydrogen or green hydrogen. Hydrogen produced from coal may be called brown hydrogen, and hydrogen produced from natural gas or petroleum might be referred to as grey hydrogen. Brown or grey hydrogen production combined with carbon capture and storage/sequestration might be referred to as blue hydrogen. Hydrogen produced with nuclear energy may be called pink hydrogen or clean hydrogen.

Generators need a rotating portion and a stationary portion, with one of the portions having a magnetic field, which induces an electric current in the other portion. This magnetic field can be provided either by permanent magnets, or by electromagnets. Because of expense, conventional generators usually use electromagnets, referred to as “field coils”, to provide the necessary magnetic field to generate an electric current.

As described in more detail below, although wind turbines generating electricity are known, commercial scale wind turbines must be connected to electrical grids in order to operate, because electricity is necessary to energize the field coils so that the generator will work, as well as to operate the yaw motor to make the wind turbine face into the wind. By “face into the wind” includes both the blades upwind of the tower and the blades downwind of the tower. Electricity is also necessary to adjust the pitch of the blades of the rotor, so as to maintain the rotation rate of the rotor in a desired range of rotor rotation rates, when the wind speed is in a desired range of wind speeds. Further, if the wind speed fluctuates to fall below the desired range of wind speeds, even with the blades at optimum pitch, the rotor must be powered to continue rotating at rotation rates within the desired range of rotor rotation rates, or other issues may arise. If the wind speed fluctuates to exceed the desired range of wind speeds, electricity is needed to power brakes for the rotor and the supervisory control and data acquisition (“SCADA”) controller system (see below). Usually a gear box or other transmission downshifts the rotor rotation rate so that the rotor drives the shaft of the generator at shaft rotation rates within a generating range of shaft rotation rates.

However, locations with wind speed within a desired range of wind speeds are often remote from electrical grids, or cannot be connected to electrical grids because grid capacity is restricted and interconnection agreements have not been negotiated with the operators of the grid, such as public utilities, or other reasons. Very importantly, when electricity is generated by wind turbines, that electricity must be used or transmitted immediately—there must be a contemporaneous demand for the electricity being generated. For commercial scale wind turbines, this means that the electricity will be sold to public utilities—no other customers could absorb all the electricity generated. This also means that, not only do transmission lines need to be constructed to reach the location of the wind turbine, but also an electrical substation also must be built, to interconnect the wind turbine with the grid. Also, because the electricity is being transmitted to the utility's grid, the electricity must be conditioned and meet the quality control standards of the utility, and also must conform to the constantly fluctuating power demands of the utility, which means that complex control systems must be implemented in the wind generator, so that the utility can coordinate the transmission of wind generated electricity with other electricity on the grid.

Wind powered electric generators, often called wind turbines, connected to the electric grid and to batteries are known, where the wind turbines provide electricity to the grid and also to charge the batteries, so that if the wind is insufficient to generate electricity as required by the utility interconnection agreement, then the batteries can provide any shortfall in energy.

Thus, there is a strong need for commercial scale wind generated energy that is not subject to interconnection agreements with electric utilities, and does not require the building of transmission lines and substations to the site, or the complex controls necessary to interconnect with a utility grid.

Hydrogen pricing: The Regensburg University of Applied Sciences. “Wherever the production of green electricity is cheap, for example with hydropower in Scandinavia or with a lot of wind and sun in Namibia, power-to-X products such as green ammonia are already cheaper than the fossil alternative.” According to an analysis from Bloomberg New Energy Finance (BNEF), green hydrogen is already cheaper than fossil hydrogen from natural gas in parts of Europe, the Middle East and Africa. It notes that a kilogram of grey hydrogen currently costs 6.71 US dollars in these regions compared to 4.84 to 6.68 dollars per kilogram for green hydrogen—due mainly to the price of gas, which has been climbing since the end of last year and shot up significantly with the Russian attack on Ukraine. “A year ago we were still paying 350 euros for a tonne of grey ammonia, whereas green ammonia cost between 600 and 700 euros,” Sterner said. “Now that the price of natural gas has multiplied, things have changed and grey ammonia cost over 1200 euros.

Green hydrogen prices have nearly tripled as energy costs climb: S&P Published Jul. 21, 2022, By Emma Penrod Scharfsinn86 via Getty Images Dive Brief: The cost of electrolytic hydrogen from renewable energy spiked as high as $16.80/kg in late July, three times recent price norms, according to S&P Global Commodity Insights.

The problems of supply and demand of natural gas to market causes the price of hydrogen to fluctuate on a regular basis. The process of making blue hydrogen is destructive to the planet's climate. The ZGen will be able to fix the price of gaseous hydrogen long-term securing supply and price security.

The ability to use renewable energy like wind and solar has severe restrictions because of transmission line congestion and those lines being controlled by utilities who decide how much renewable energy to accept. There are over 100,000 megawatts of stranded wind farms worldwide due to lack of transmission system access that have not been built even though they have commercial wind resource and are fully permitted with community approval and in some cases construction ready. ZGen operates without utility transmission connection.

Standard practice today for large renewable hydrogen production is still utilizing the existing wire transmission systems. Offshore wind farms in the North Sea are producing AC electricity sent to shore by transmission lines to substations and then sent to electrolyzers in warehouses or containers to produce the green hydrogen. These methodologies are dependent on congested restrictive, expensive transmission systems that are costing more and not allowing renewable energy to expand the way it needs to protect the planet. Today most all the electric vehicles are being charged by traditional fossil fuel plants, the only saving is they're not putting carbon gas out on the road.

U.S. Pat. No. 11,236,864 B1 to Ewan et al, incorporated herein by reference, discloses transportation and distribution of hydrogen using pipelines, lighter than air airships and other means.

### DISCLOSURE OF INVENTION

As described in more detail below, the present invention is a wind powered hydrogen generator with storage that is decoupled from an electric grid, including a tower, a nacelle with electric yaw capability mounted on the tower, and a generator having field coils and a rotatable shaft inside the nacelle, decoupled from the electric grid. The generator generates electricity when the shaft is driven to rotate within a generating range of shaft rotation rates. A rotor having a hub and blades with an adjustable pitch is mounted on the hub. The rotor is drivably connected to the shaft, so that the rotor rotatably drives shaft, so that when the blades are adjusted to be at a desired pitch and the nacelle yaws so the rotor faces substantially into the wind, and the wind is in an operating range of wind speed, the wind drives the rotor to rotate at a rotor rotation rate within a desired range of rotor rotation rates, which drives the shaft to rotate at a shaft rotation rate within the generating range of shaft rotation rates, which drives the generator to generate electricity. A yawing motor is connected to the nacelle to yaw the nacelle to cause the rotor to face substantially into the wind. A start-up fuel cell decoupled from the electrical grid is electrically connected to the generator, the pitch adjustable blades and the yawing motor. Optionally, a SCADA controller can be provided that controls start-up operating procedures, including controlling the pitch of the blades and the yawing motor. The start-up fuel cell provides power to the generator to energize the field coils, to the pitch adjustable blades to adjust pitch of the blades to maintain rotation rate of the rotor within the desired range of rotation rates, and to power the yawing motor. Electrolyzers mounted in the tower are electrically connected to the generator (potentially but not necessarily more efficient DC generation to DC run electrolyzers) to generate hydrogen from the electricity generated by the generator. Hydrogen impermeable piping is connected to the electrolyzers and mounted on the tower to receive the hydrogen for storage. In this manner, the wind powered hydrogen generator can be sited in locations having wind speeds within the operating range of wind speeds, regardless of whether the generator is connected to the electric grid. In this manner, power from hydrogen stored in the piping can be used or transported as and when needed, even when wind speed may be outside the operating range so that the generator does not generate electricity, so that intermittent power from the wind in locations remote from electric grids is converted to firm energy.

Preferably, the piping is mounted on the tower by being coiled on the interior of the tower.

Alternatively, the piping is mounted on the tower by being coiled on the exterior surface of the tower.

Preferably, the piping comprises fiber reinforced polymer piping.

Preferably also, the rotor is drivably connected to the shaft by a gearbox that drives the shaft at shaft rotation rates within the generating rage of shaft rotation rates when the rotor rotates at rotor rotation rates within the desired range of rotor rotation rates.

In an alternative embodiment where the generator does not require energizing of field coils, including (without limitation) where the generator has permanent magnets, the invention comprises a tower, a nacelle yawably mounted on the tower, a generator having a rotatable shaft inside the nacelle, decoupled from the electric grid. The generator generates electricity when the shaft is driven to rotate at shaft rotation rates that are within a generating range of shaft rotation rates. A rotor having a hub and blades with an adjustable pitch is mounted on the hub, and the rotor is drivably connected to the shaft, so that the rotor rotatably drives the shaft. In this manner, when the blades are adjusted to be at desired pitches and the nacelle yaws so the rotor faces substantially into the wind, and the wind is in an operating range of wind speed, the wind drives the rotor to rotate at rotor rotation rates within a desired range of rotor rotation rates, which drives the shaft to rotate at shaft rotation rates within the generating range of shaft rotation rates, which drives the generator to generate electricity. A yawing motor is connected to the nacelle to yaw the nacelle to cause the rotor to face substantially into the wind. A start-up fuel cell decoupled from the electrical grid is electrically connected to the pitch adjustable blades and the yawing motor. The start-up fuel cell provides power to the pitch adjustable blades to adjust pitch of the blades to maintain rotation rates of the rotor within the desired range of rotor rotation rates, and to power the yawing motor to cause the rotor to face substantially into the wind. Electrolyzers are mounted in the tower and electrically connected to the generator to generate hydrogen from the electricity generated by the generator. Hydrogen impermeable piping is connected to the electrolyzers and also to the start-up fuel cell, and mounted on the tower, to receive the generated hydrogen for storage and also to provide said generated hydrogen to the start-up fuel cell. In this manner, the start-up fuel cell can be refueled from the generated hydrogen in the impermeable piping as needed, so that the wind powered hydrogen generator can be sited in locations having wind speeds within the operating range of wind speeds, regardless of whether the yawing motor and the blades can be connected to said electric grid, and hydrogen stored in the piping can be used or transported as and when needed, even when wind speed may be outside the operating range so that the generator does not generate electricity, whereby intermittent power of wind in locations decoupled from electric grids is converted to firm energy.

This invention provides several efficiencies:

Energy losses from inverting direct current (DC) electricity to alternating current (AC), and from rectifying AC to DC, for electrolyzers, can be avoided or minimized.

Costs and delays of building transmission lines and substations to wind power locations can be avoided.

Costs and delays and technical requirements of requests for proposals, bidding, negotiating, and signing utility interconnection agreements can be avoided.

Complex quality control requirements for conditioning generated electricity for interconnection to a utility grid can be avoided.

The invention is autonomous and does not require any interconnection—the generated hydrogen can be stored until ready to be transported away in any manner available, including vehicles (including trucks and air ships) and pipelines. Alternatively, the generated hydrogen can be liquified or otherwise processed for storage or transportation.

Each unit embodying the invention can have its own start-up fuel cell, or a single start-up fuel cell can power two or more units (such as at a wind farm). Alternatively, an export fuel cell (a fuel cell that receives hydrogen from the unit and creates electricity for export) that is on-site, can also serve as a start-up fuel cell.

The subject technology, renewable hydrogen generation, provides a means of producing renewable “Green” hydrogen more efficiently, without pollution, with fixed Least Cost of Energy (LCOE) prices, utilizing free fuel while improving climate change.

The ZEUS Renewable Hydrogen Generator (ZGen) is much different than just filling an existing wind turbine tower with hydrogen and transmitting wind energy via transmission lines to eiectrolyzers in a container or aggregated in a warehouse with H2 storage cylinders nearby. The ZGen is a paradigm shift for wind energy from utility generation and wire connected electricity to transportable “wireless” electricity and to include transportation fuels from on board wind generation to electrolysis to storage and transformance back to electricity via fuel cell or distributed directly as a gas from the de-coupled from the transmission system wind turbine. Ultimately the design will create the LCOE Green hydrogen available to existing and new hydrogen markets. ZGen producing ZGas autonomously, more efficiently by design, using inexpensive wind energy to achieve the Department of Energy's “Earth Shot” goal of $1 per kilogram.

Why it is considered novel: The concept is to take existing and proven wind technology and prioritize its operation by creating ZGas onboard and not connecting and selling electricity to the utility through existing transmission systems unless utility specifically requested renewable electricity. Instead, electricity from the AC or DC wind generator is used by the included vertically stacked AC or DC electrolyzers that will split the water molecule into ZGas, hydrogen and Renewable Oxygen Gas (ROGas) directly within the proposed ZGen 80 m tall tower. The “Green” ZGas created is then stored in FRP coiled inside or outside the modified designed tube tower. The “Green” Oxygen can be also stored in FRP pipe for commercial sale or released into the atmosphere.

The ZEUS generator will utilize the FRP pipe as the main ZGas hydrogen storage system (ZGSS). One mile of 6.5″ FRP will hold 5000 Kg at 2500 psi. One mile of the FRP pipe coiled around the 13′-14′ diameter tower will reach to 60′-70′. Additional coils can be stacked higher depending on acceptable safety loads, weight and desired storage capacity.

Spoolable or coiled FRP Pipe has been developed to provide the oil and gas industry with a family of products to address the market requirements for a reliable, corrosion-resistant, and cost-effective solution used during the production and transportation of oil and gases. FRP is a continuously manufactured Fiberglass-Reinforced Polymer pipe that is designed for production gathering, transmission, distribution, and injection applications. FRP pipe as a short and long term storage of the ZGas in a wind turbine is unique to the ZGen design. FRP is a product that consists of an inner thermoplastic pressure barrier that is reinforced by high strength glass fibers embedded in an epoxy matrix. The ZGSS will include all necessary parts for operation and safety including connection elbows (90°, 45°, 30°, 22.5°, 15°, 11.25°, tees, couplings, flanges, flange rings, nipples, swages, reducers, adapters. The FRP pipe stores up to 3,500 psi, depending on size. Up to 212° F. (100° C.) and has a fifty-year life.

It is the product of the whole of the components of the ZGen that creates the opportunity to produce and store ZGas as it has never been done. ZGen can produce ZGas anywhere there is suitable wind resources and when produced from a commercial size ZGen wind farm at prices cheaper than natural gas manufactured hydrogen gas. The result will be unpredictably better than the expected result of this combination of components making the lowest cost Green Hydrogen available to the market.

### BRIEF DESCRIPTION OF DRAWINGS

FIG. 1 is a conceptual diagram of wind generated electricity to electrolysis to ZGas production to FRP storage (ZGSS) at 2500 psi, to ready available for distribution or to fuel cell for electricity, heating and return to water all created at the turbine. Each ZEUS turbine is designated its own start-up fuel cell but in other embodiments, a stationary fuel cell could operate more than one hydrogen generator.

FIG. 2 is a perspective view of an embodiment of the invention with storage in exterior coiled piping.

FIG. 3 is a partial cutaway view of an alternative embodiment of the invention, showing storage in interior coiled piping.

FIG. 4 is an interior view of major components enclosed by circular support frame.

FIG. 5 is an interior view of the invention showing major components without the support frame.

FIG. 6 is a perspective view of an alternative embodiment of the present invention with cutouts or shelves projecting into the interior to support interior coiled piping.

FIG. 7 is a perspective view of an interior section of the invention with stacked electrolyzers.

FIG. 8. is a perspective view of an interior section with stacked compressor and power controls and SCADA systems.

FIG. 9 is a perspective view of an interior section with water chillers and on-board hydrogen generation fuel supply.

FIG. 10 is a perspective view of coiled piping for hydrogen and oxygen storage.

FIG. 11 is a perspective view showing from the base to the wind generator nacelle and components and piping.

FIG. 12 is an elevational cutaway view of the invention showing the major components.

FIG. 13 is a semi-transparent view of the lower portion of the tower of the invention, through the coiled piping on the exterior.

FIG. 14 is an elevational view of the lower portion of the tower of the invention showing major components, with piping omitted for clarity.

FIG. 15 is an elevational view of the lower portion of the tower showing major components, with piping coiled on the interior.

FIG. 16 is a perspective view of a wind farm with multiple units of the invention, with piping coiled on the interior, as shown by a partial cutaway view of one unit.

FIG. 17 is a perspective view of a wind farm with multiple units of the invention, with piping coiled on the exterior.

FIG. 18 is a perspective cutaway view of the lower portion of the tower of the present invention.

FIG. 19 is a conceptual view of a wind farm with multiple units of the present invention, with piping coiled on the exterior of the towers, with water and hydrogen gas piping underground.

FIG. 20 is a view from the top of the interior of a tower of the invention, with the piping coiled on the outside.

FIG. 21 is a partial cutaway view from the top of a tower of the invention, with the piping omitted for clarity.

FIG. 22 is a top view of a lower section of the embodiment of the invention with the piping to be coiled on the exterior.

FIG. 23 is a view of a lower portion of a tower of the embodiment of the invention with the piping to be coiled on the exterior.

FIG. 24 is a perspective partial cutaway view of the lower portion of the tower with coiled piping on the exterior.

FIG. 25 is a view of the interior of the tower, with the exterior of the tower shown adjacent, showing the interior cutout shelf folded inwardly to provide support for piping coiled on the interior surface.

### BEST MODE FOR CARRYING OUT INVENTION

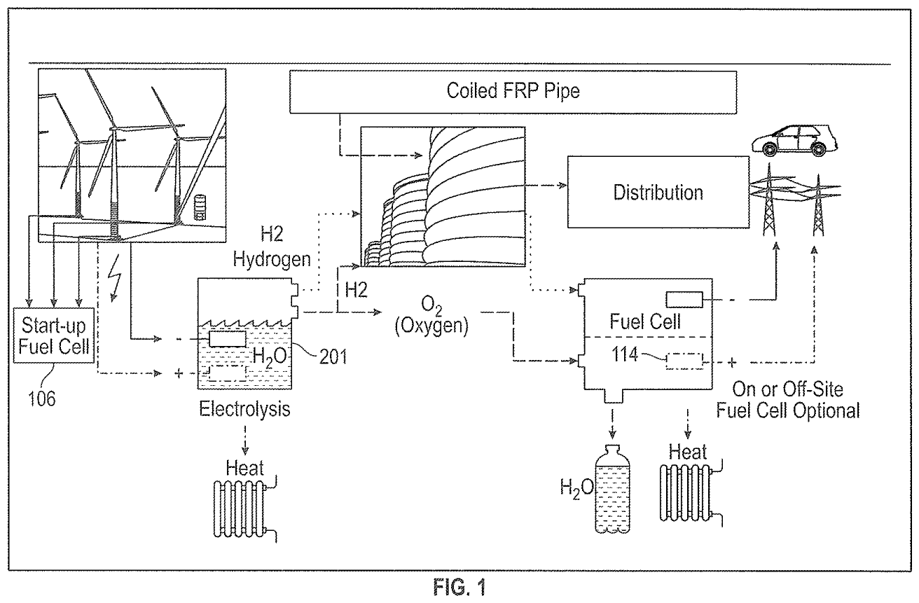

Referring to FIG. 1 is a schematic diagram depicting the production of Renewable Hydrogen Gas (RHG) from wind energy using electrolysis and coiled FRP pipe for storage and distribution to the hydrogen gas markets or to reform hydrogen with oxygen in a fuel cell to make electricity on or offsite. The Start-up Fuel Cell 106 is shown as part of the ZEUS Hydrogen Generator as a critical component for starting and assisting in the control and operation of the wind turbine. Depending on the type of electrolyzer and fuel cell, ie. PEM, Alkaline, Phosphoric Acid, Molten carbonate, and others will produce residual that can be reprocessed to heat water (low temperature heat) or high temperature heat that can be utilized as combined heat and power.

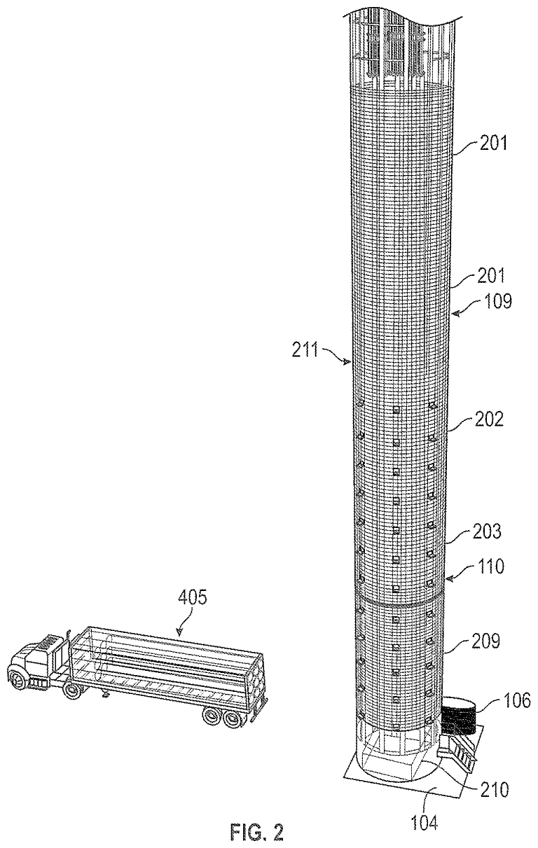

Referring to FIG. 2 is displaying the ZEUS hydrogen turbine lower portion in 3-dimensional semitransparent view revealing the unique exterior coiled FRP hydrogen 107 and oxygen 108 storage systems. The modified tubular tower with exterior cut outs 111 seen as well as the Start-up fuel cell 106.

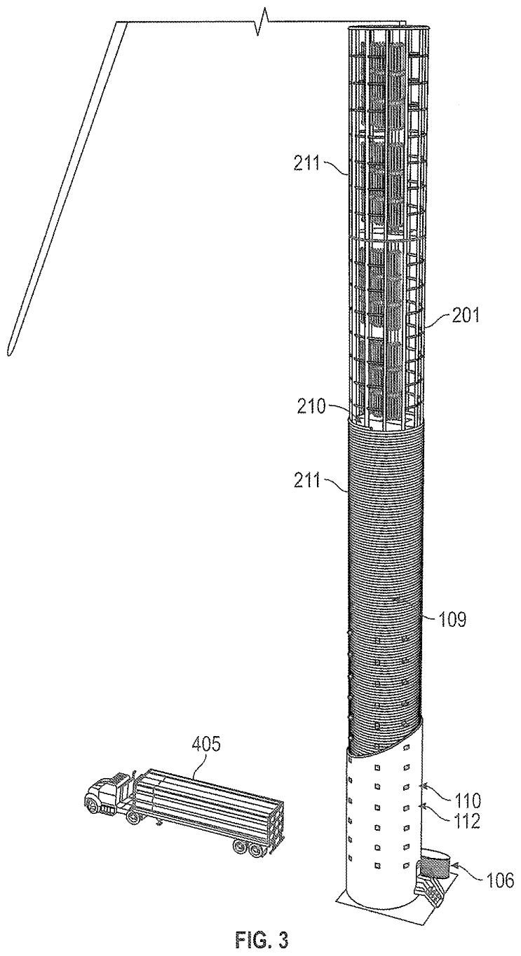

FIG. 3 shows, in 3-dimensions, the partially enclosed ZEUS hydrogen generation system within the modified tubular tower 101. The semitransparent illustration shows the vertically stacked Electrolyzers 201, surrounded by the equipment Section Component Framing 211. The figure shows 100 feet (30.48 m) height of 6½″ (0.165 m) FRP coiled pipe for the storage of the hydrogen and the oxygen created by the electrolysis process. The bottom of the illustration shows the Start-up Fuel Cell 106. FIG. 3 shows the dimensions of the sections as the ZEUS turbine would be assembled in 20′ (6.096 m) and 40′ (12.192 m) sections. The sections represent how the turbine will be erected in connecting the section shelves 210 and the section component frames 211 with the components inside. Erection of the modified tubular tower 101 would be similar to welding tower sections for a typical wind turbine tower construction and then the FRP is coiled around the section component frames and then the FRP is surrounded by the tower for the interior FRP storage system 109.

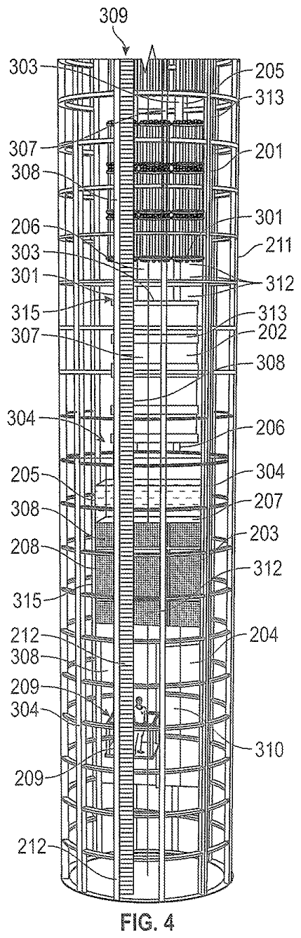

With reference to FIG. 4 we have the sections component framing 211 that's surrounds and secures the various hydrogen generation equipment including the electrolyzers 201, compressors 202, cooler or heat recovery 203, power controls 204, on-board water storage 205, chillers 208 and hydraulic lift 209. The frame is designed to be transported by road, rail or air vehicle to the site where it will be assembled in 20′ (6.096 m) and 40′ (12.192 m) sections depending on the components enclosed. The tubular tower 101 sections are typically erected, stacked and welded in place on site. The components can be assembled in Section Components Framing 211 at the factory or on site. Section Shelf 210 flooring encloses the section components framing 211 and provides components stage flooring when erect. The hydraulic lift 209 is shown with its guided track 212 for raising and lowering the hydraulic lift platform 209 for routine maintenance, equipment replacement, and operation. The Section Components Framing 211 is designed to fit into the typical modified tubular tower with room for the 6½″ (0.165 m) diameter FRP storage piping 109 to be mounted on the interior cutouts 112 of the tower. The component section framing 209 is designed to secure the interior components and maintain structural integrity for the inner connection of designed piping 205, connectors 301, coupling's 303, electrical conduits 304, hydrogen gas piping 307, RHG sensors 308, and electric cables 309, as well as equipment cabinet enclosures 310, various pumps 312, valves 315, separators 313, and computer systems including SCADA 310.

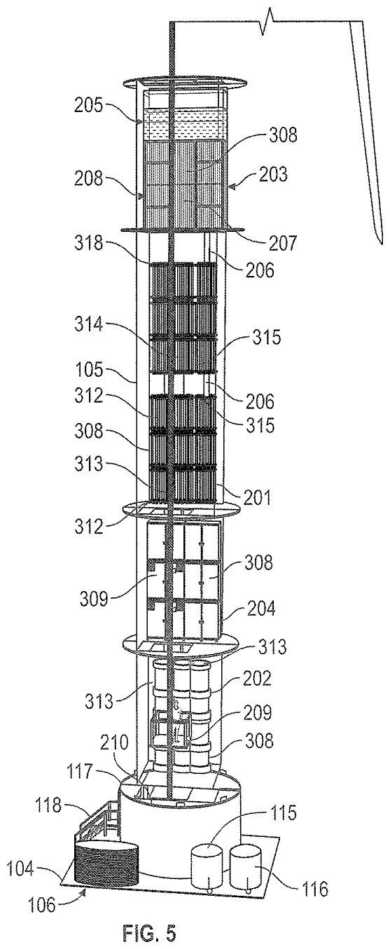

FIG. 5 shows all of the major components for the ZEUS Hydrogen Generator.

The stacking arrangement of the components may vary depending on final engineering requirements. The 20′ (6.096 m) and 40′ (12.192 m) sections are identified as well as designated interior components. The top section shows the water supply and the cooling tower 208 for the Electrolyzers 201. The Electrolyzer 201 is an apparatus that produces hydrogen to do a chemical process capable of separating the hydrogen oxygen molecules of which water is composed using electricity. The wind generator in this case will provide the renewable electricity which then creates Renewable Hydrogen Gas (RHG). There are three main types of electrolyzers 201: proton exchange membrane (PEM), alkaline and solid oxide. These different electrolyzers function in slightly different ways depending on the electrolyte material involved. The entire system also contains electrolyzer pumps 312, electrolyzer vents 314, electrolyzer valves 315, separator 313, and other components. After electrolysis the included compressors 202 are able to compress the lighter-than-air hydrogen to approximately 2500 PSI. FIG. 5 shows the Section Shelfing 210 as well as the hydraulic service lift 209. Also seen at the bottom of the tower is the entrance access door 117 and access stairway 118, start-up fuel cell 106 and the RHG and oxygen distribution storage tanks 115 and 116.

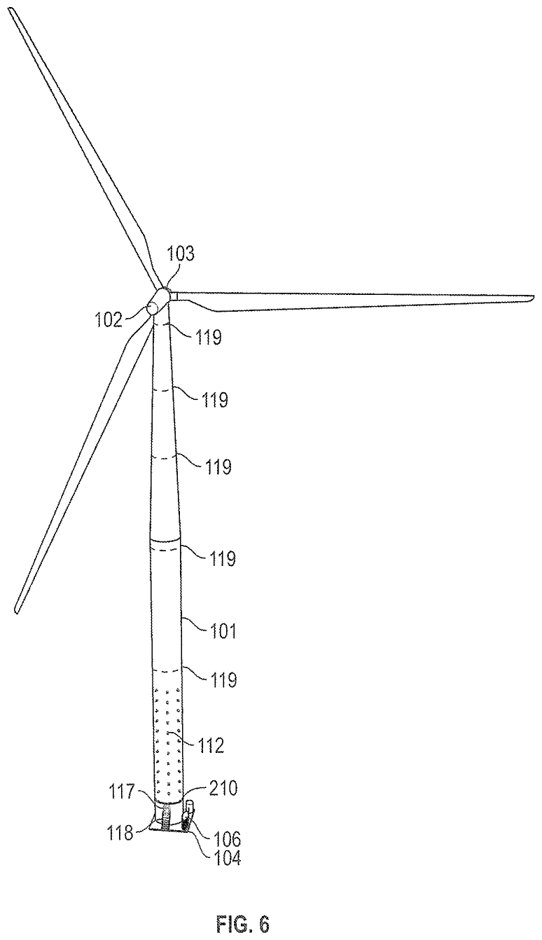

FIG. 6. is the depiction of the full ZEUS Hydrogen Generator wind turbine, rotor 103, nacelle 102, and modified tower 101. From the outside this is what a typical wind turbine would look like except for the cut outs 112 and 119 in the tower. It is necessary for safety to have hydrogen escape ventilation along the modified tower 101 in the form and design using cutouts, similar to cut outs 109, every 40′ (12.192 m) up with one row circling the tower 119. The cutouts 119 will act as escape vents for any hydrogen gas leakage. As part of the cut outs 119 will be extraction or blower fans 119 to assist in removing any leaked hydrogen gas from the confines of the tower. Not seen here are all the interior components that make up the ZEUS Hydrogen Generator. The typical wind turbine would be hollow inside with only a mechanical lift ladder and electric cables coming from the generator to the control systems at the bottom. The typical large commercial wind turbines of today make electricity that sells to a utility through the local transmission systems if available.

The ZEUS turbine is a paradigm shift for wind energy from the market of utilities purchasing wind generated electricity to be supplied to the utility's grid pursuant to an interconnection agreement, to manufacturing hydrogen on-board without the necessity of utility interconnection. The results are multiple new markets for wind energy by producing a renewable hydrogen product that is storable and will operate without the wind turbine having to operate in rotation. Hydrogen gas is a larger volume longer duration storage system compared to batteries that are used today to provide small amount and short duration storage for scheduled electricity delivery.

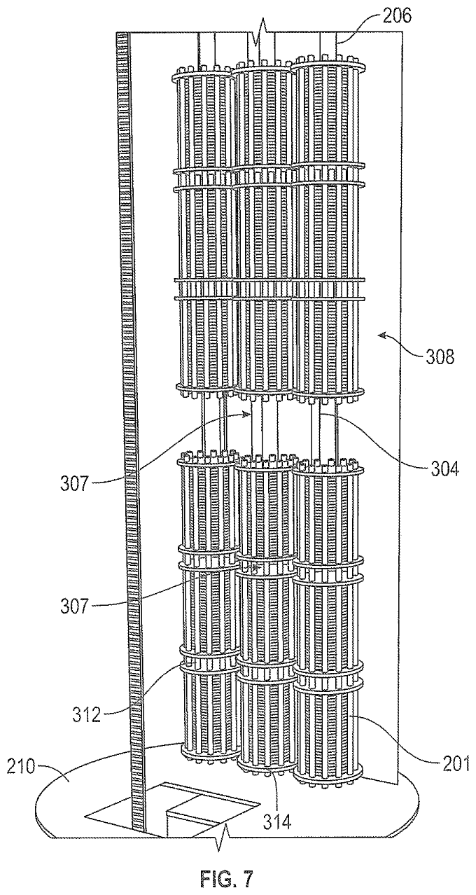

Referring to electrolyzers 201 in FIG. 7 they can range in size and function. Electrolyzers 201 can be scaled to meet a variety of input and output ranges, varying in size from small industrial plants installed in a shipping container to large scale centralized production facilities that can deliver the hydrogen at commercial scale. There are three main types of Electrolyzers 201: protonic exchange membrane PEM, alkaline and solid oxide. These different types of Electrolyzers 201 function in slightly different ways depending on the electrolyte material involved. Both alkaline and PEM Electrolyzers 201 can deliver on site and on demand hydrogen, pressurized hydrogen without additional compression and 99.9% pure, dry and carbon free hydrogen.

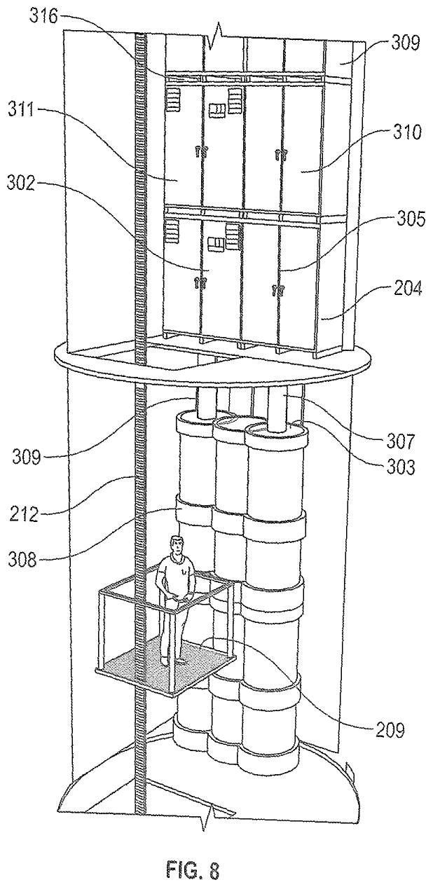

FIG. 8 shows the compression system which is part of the Electrolyzer 201 and can be adjusted to various required amounts of compression up to 3000 PSI. FIG. 8 includes the Equipment Cabinet Enclosures 310, system controls and SCADA 305, electric power cables 309 and conduit 304, Processors, Programs and memory system 302 are all part of the power controls 204 component which monitors, regulates and controls power 311 to the electrolyzer stacks 201 at a fixed stack current. Electrolyzers 201 accept DC or AC power input depending on wind generator type and from the on-board power converter or directly from the DC wind generator to DC electrolyzer 201 which will provide higher efficiency avoiding inversion and rectifying.

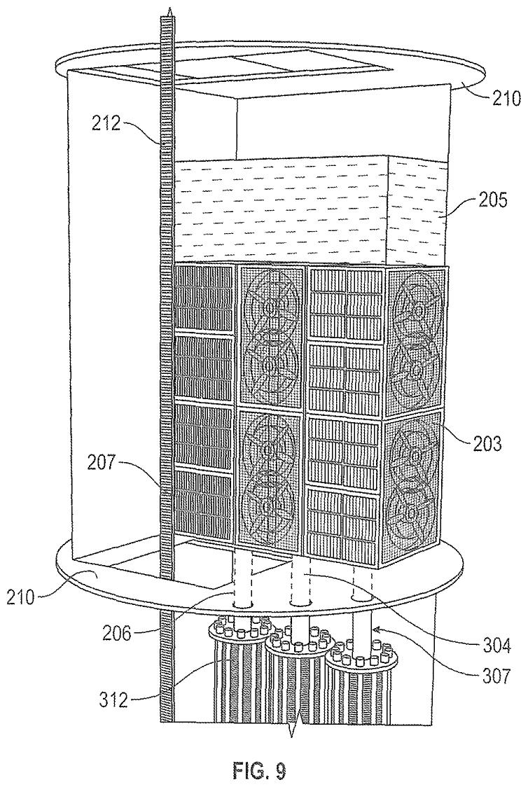

FIG. 9 shows the water supply component 205 and chilling system 208 with section shelves 210 and including the hydraulic lift opening and hydraulic lift track 212. Water is the fuel for electrolysis that creates the hydrogen. For the ZEUS generator, wind energy is the fuel for electricity which is provided to the Electrolyzer 201 creating renewable hydrogen gas (RHG). Water is delivered to the base of the turbine via underground pipe system 404 or large on-site water tank 406.

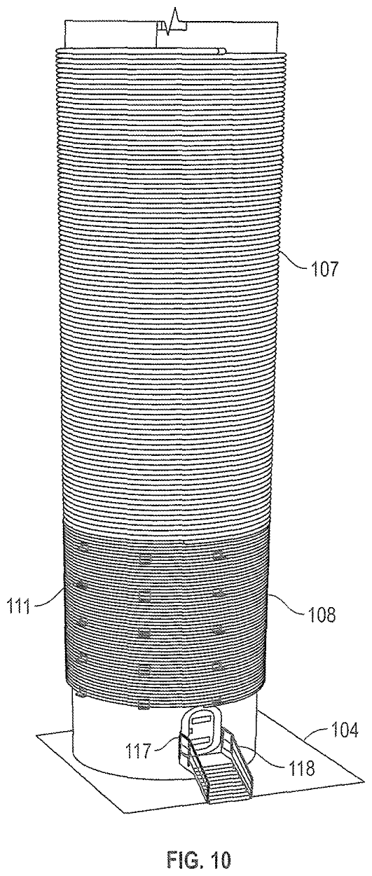

Referring to FIG. 10 shows the coiled and spiraled FRP pipe for collecting the manufactured compressed hydrogen and compressed oxygen. One-mile (1609.344 m) of 6½″ (0.165 m) FRP pipe 107 will hold approximately 5000 kg at 2500 PSI and will stretch approximately 60′ (18.288 m) up the circumference of the tower. The beginning of the coil starts at 10′ (3.048 m) above the base and slightly above the front entrance. The end of the FRP pipe if on the inside continues down the side of the tower to the base where it is held in storage in the distribution tanks 115 116. If the FRP is on the exterior, then it is extended down the outside of the tower to the distribution tanks 115 116. The modified tower 101 will have a hole allowing exterior FRP pipe coupling to connect to the inside FRP.

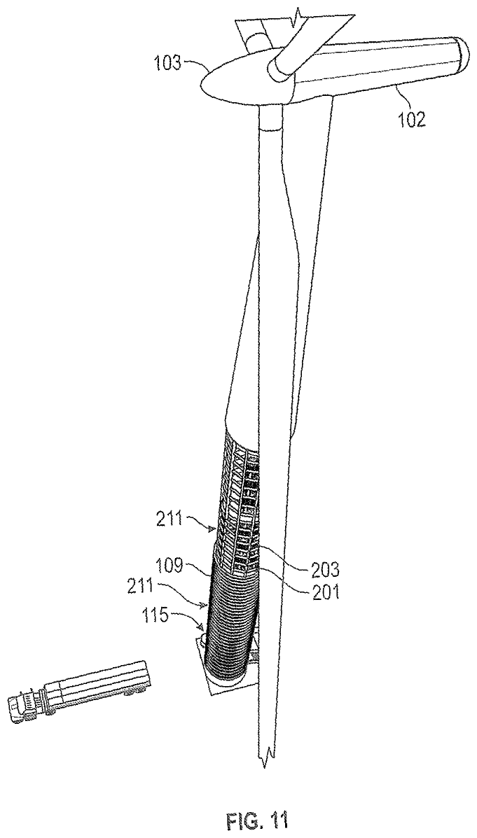

FIG. 11 refers to the ZEUS Hydrogen Generator in perspective from the turbine nacelle 102 to the base of the tower 104. The type of wind generator blades and rotor 103 are generic. Any of the commercial large wind manufacturers are available to supply the power generating system for the Zeus hydrogen turbine. The turbine generator 102 and the turbine modified tubular tower 101 can also be supplied from various wind turbine manufacturers.

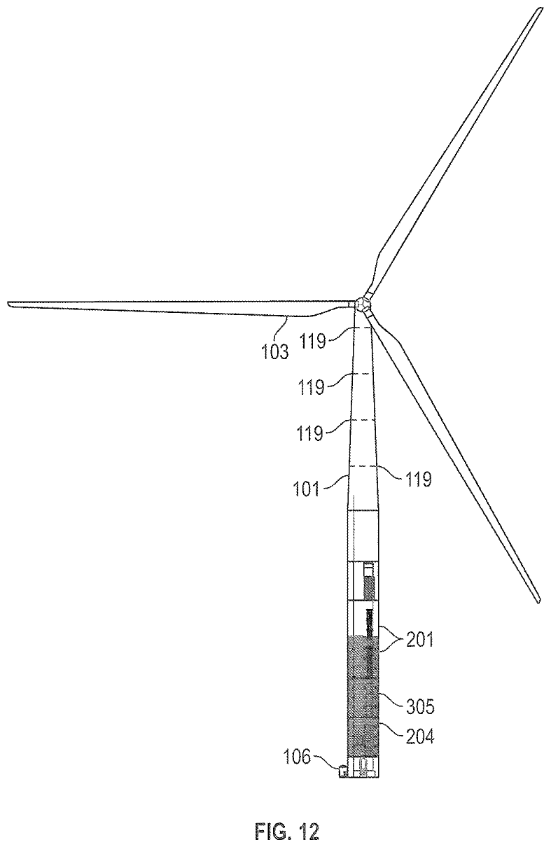

FIG. 12 shows the full wind turbine from rotor tips to the base of the tower and includes all the components and a Start-up Fuel Cell 106 and distribution thank from the front view. As the wind speed increases the Start-up Fuel Cell 106 will supply the electricity to activate the yaw system and rotate the turbine generator nacelle into the wind where the rotor blades 103 electrically pitch to catch the wind. In low winds the start-up fuel cell 106 will provide electricity to Power Controls 204 to maintain steady electrical input at various wind speeds along the power curve of the designated wind turbine generator 102. Once the wind turbine generator is up to speed the Start-up Fuel Cell 106 will turn power control over to the system Power Control 204 and SCADA 305 system that will control the electrical output supply to the Electrolyzers 201 and other components.

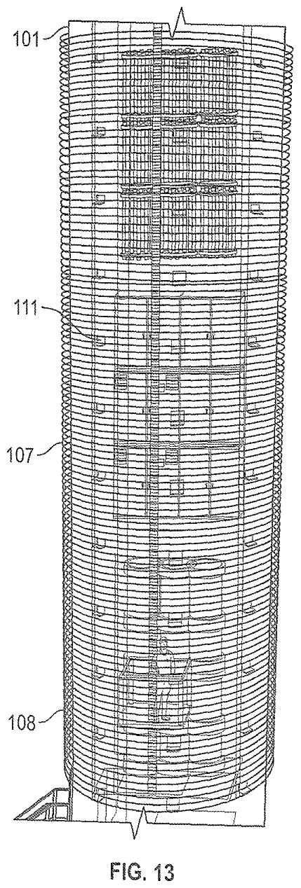

FIG. 13 shows a semitransparent 3-dimensional illustration of the 6½″ (0.165 m) FRP pipe on the exterior 107 of the tower with the tower cut outs 111 for exterior FRP 107 support. After electrolysis the hydrogen gas generated is stored in this FRP pipe until distributed or utilized for electricity.

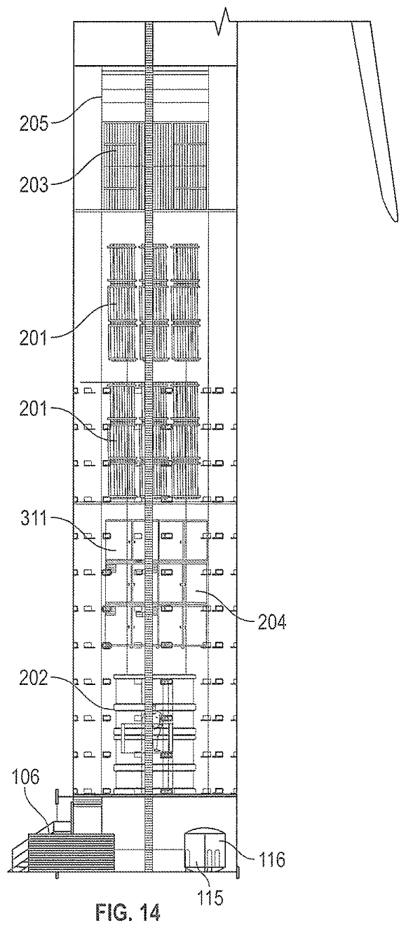

FIG. 14 illustrates the sideview section of the lower tower showing the inside folded cut outs 112 for the tower, and the stacked components with section shelving 210, as well as the Start-up Fuel cell 106 and the distribution tanks 115 116.

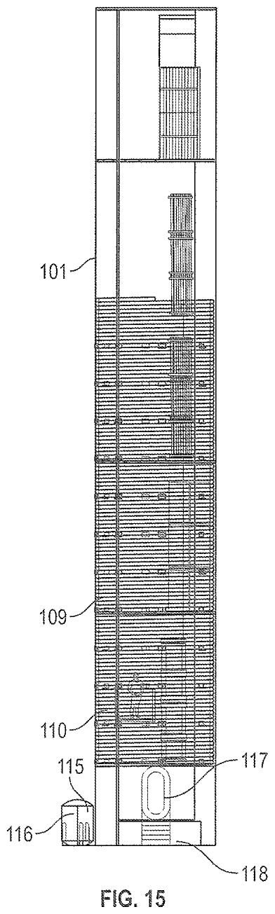

FIG. 15 as the front view is similar to FIG. 14 except that it includes the interior FRP piping 109 showing the cut out folded inside 112 the tower. The FRP pipe can be coiled, and spiral stacked on the interior 112 or the exterior 111 of the modified tube tower 101 depending on requirements of the development. Coiled FRP on the outside 111 can also be accommodated as a retrofit to existing wind turbines and allow for the convenient and efficient storage of hydrogen at the wind turbine.

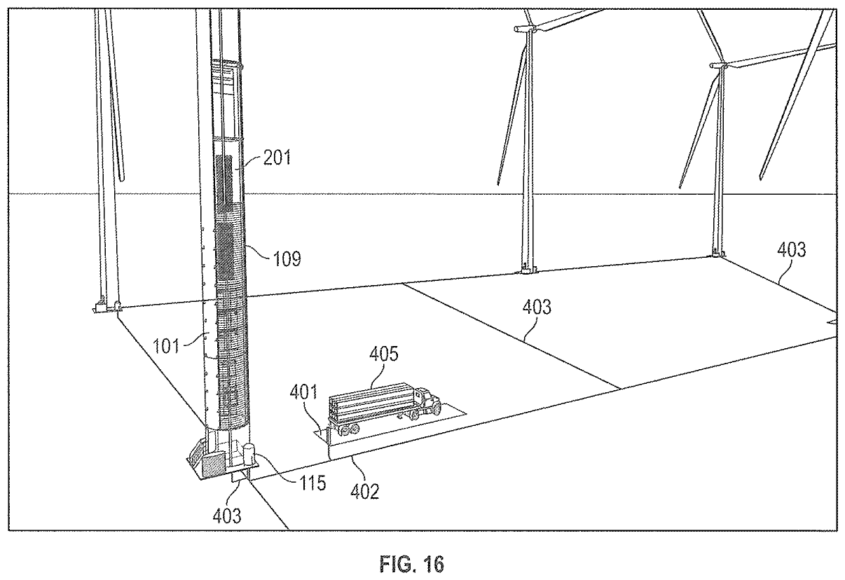

In reference to FIG. 16 we see a ZEUS hydrogen producing wind farm with interior FRP storage 109. After the ZEUS hydrogen generator manufactures RHG on-board it is compressed and stored at 2500 psi and is held in the distribution tank 115 until it can be delivered via FRP pipe to the fuel connection post 401, to a tube trailer 405, to a dirigible for air transport, by rail tanker, or the underground FRP pipe distribution system between turbines 403, or shipped via FRP pipe through new distribution easements or FRP inserted in existing natural gas pipelines.

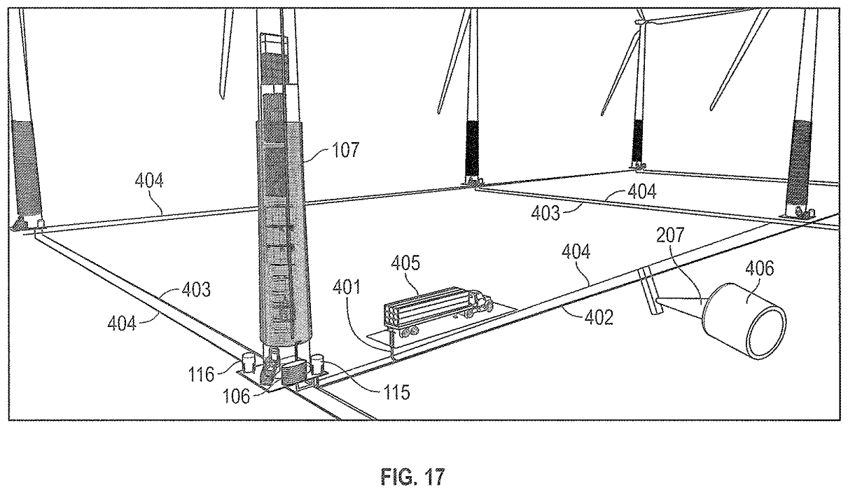

FIG. 17 is similar to FIG. 16 except it shows the FRP pipe on the exterior of the tower 107 and shows water supplied underground 404 to each individual wind turbine generator where it is supplied to the water storage on-board 205. Large water storage 406 for electrolysis is stored centrally on the ZEUS wind hydrogen farm and distributed to all the turbines with water pump 207, with electricity for pumps and other parasitic loads coming from the export fuel cell 114. Also show is the Start-up Fuel Cell 106.

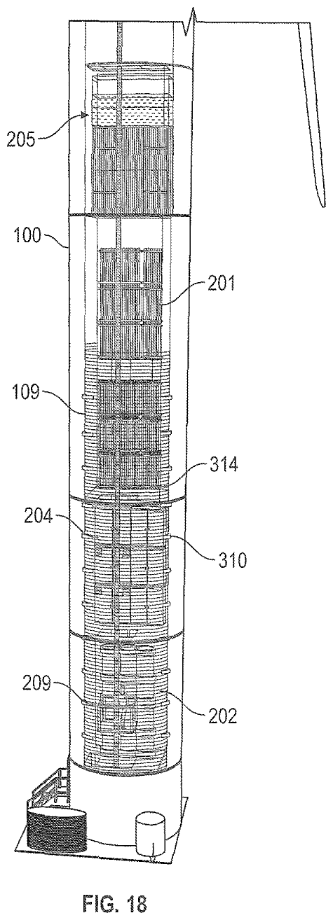

FIG. 18 shows a 3-dimensional semitransparent side view of the ZEUS Hydrogen Generator 100 components with FRP pipe on the interior 109 of the tower.

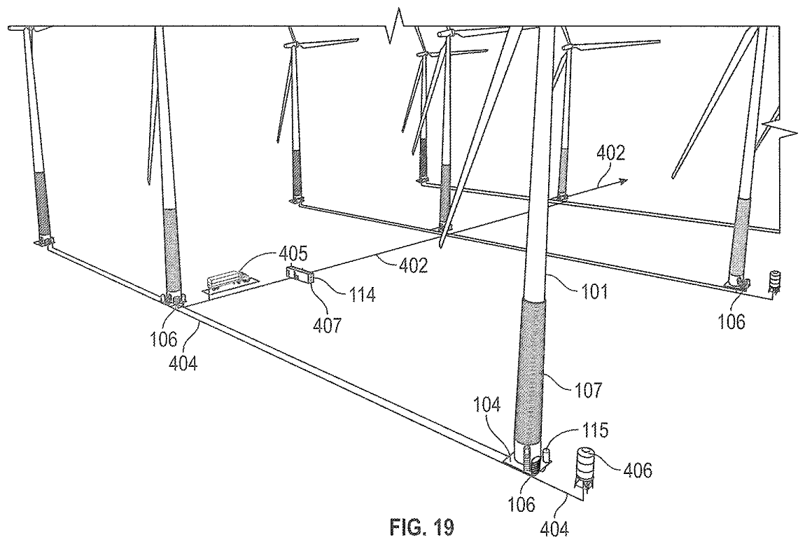

FIG. 19 illustrates the RHG fueling station with the underground FRP storage and distribution to market 402, underground FRP storage and distribution between turbines 403, a RHG storage and transport tractor trailer 405, and the stationary fuel cell 400 to export electricity from the ZEUS hydrogen producing farm. The stationary export fuel cell 114 can also be located at an offsite off-taker. When the wind turbine rotor comes up to speed and the wind turbine is producing electricity, that electricity goes to the Power Controls 204 where the system controls and SCADA 305 will allocate electricity to the Electrolyzers 201 and other necessary equipment to operate hydrogen production compression and storage as well as continue to assist operating the wind turbine generator 102. Since the wind turbine generator operates intermittently depending on the wind resource the output to the generator will vary and the Electrolyzer 201 power supply will adjust accordingly to 311 supervisory controls. Sensors 308 and 311 will control the movement of hydrogen to the Compressors 202 and then to the FRP storage and safety equipment sensors 308 and RHG sensors 308 will maintain integrity and safety and security of the operations and report any hydrogen leaks. If a leak is determined in the ZEUS turbine the system will automatically shut down and describe the malfunction. The system will not restart until an official operator gives authority to restart.

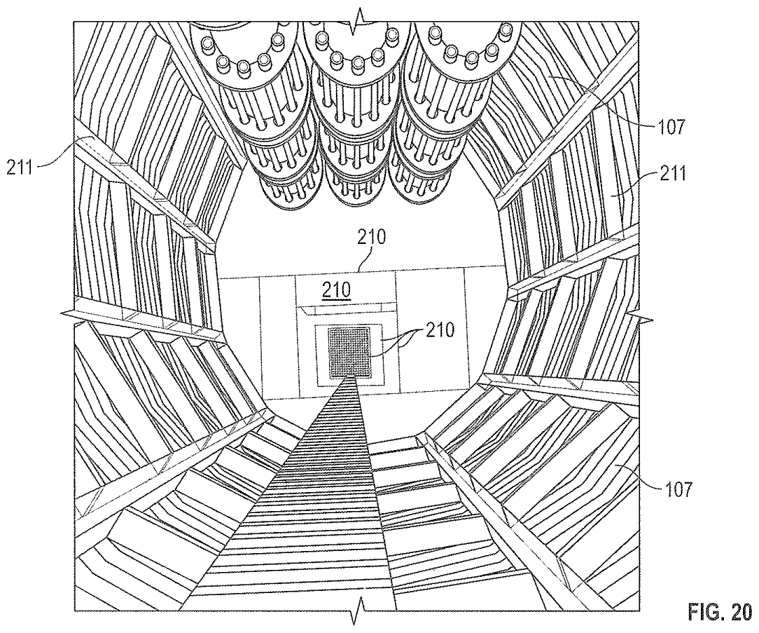

FIG. 20 provides the view from the top of the interior of the modified tubular tower 101 Including the Section Components Framing 211 as well as the Section Shelf 210 flooring and the lift access hatches. Partial showing of Electrolyzers 201 are shown as example. The FRP is shown on the exterior 107 of the Section Components Framing 211.

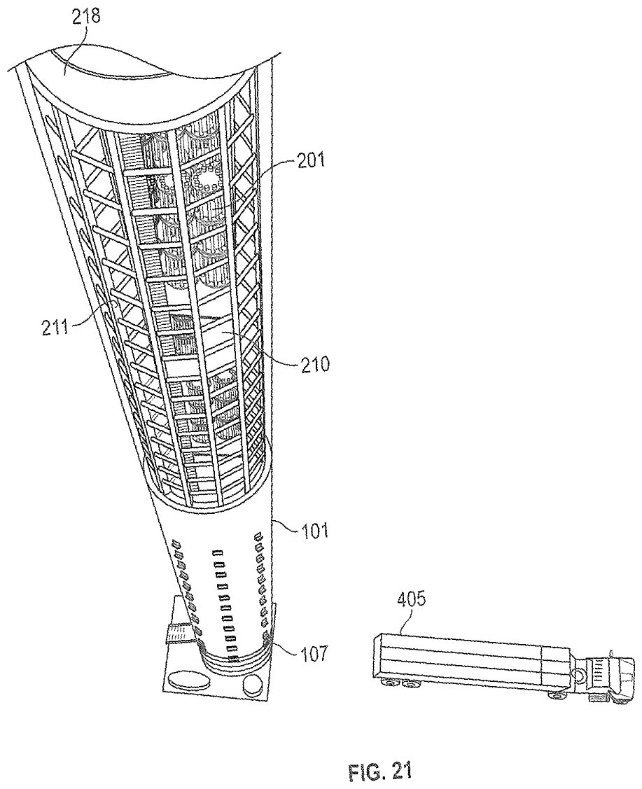

FIG. 21 shows a down looking perspective of a semitransparent ZEUS turbine with exterior FRP 107.

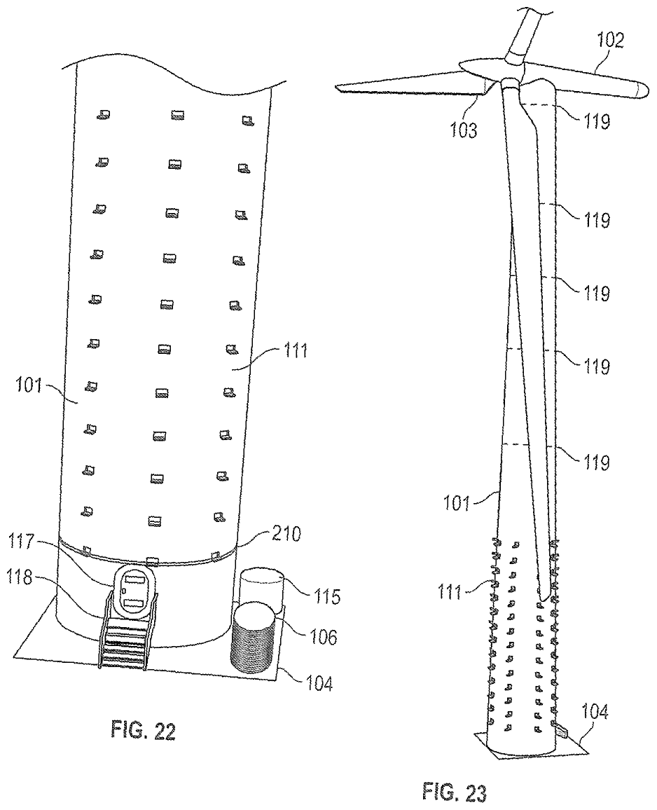

FIG. 22 through FIG. 25 show the different views of the turbine modified tubular tower 101. Referring to FIG. 22, the 3-D illustration shows the tower cutouts 112 of the tower folded out. The lower cut outs 111 are for the oxygen FRP pipe 108 with the higher cut outs 111 being support for the upper hydrogen FRP pipe.

FIG. 23 illustrates full ZEUS Hydrogen Generator. The lower portion of the modified tubular tower 101 shows the modification where the exterior tower cut outs 111 are seen circling the tower. The modified tower 101 shows the upper tower sections with ventilation cut outs 119.

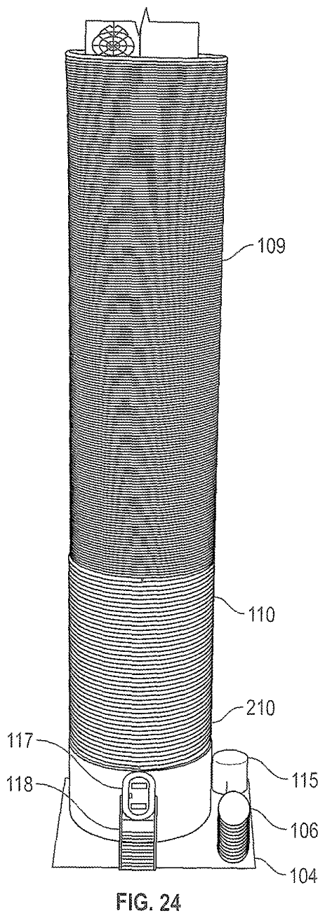

Referring to FIG. 24, shows the ZEUS turbine frontal 3-dimensional view of the FRP pipe 109 for hydrogen on the top with the FRP pipe for oxygen 110 on the bottom exterior.

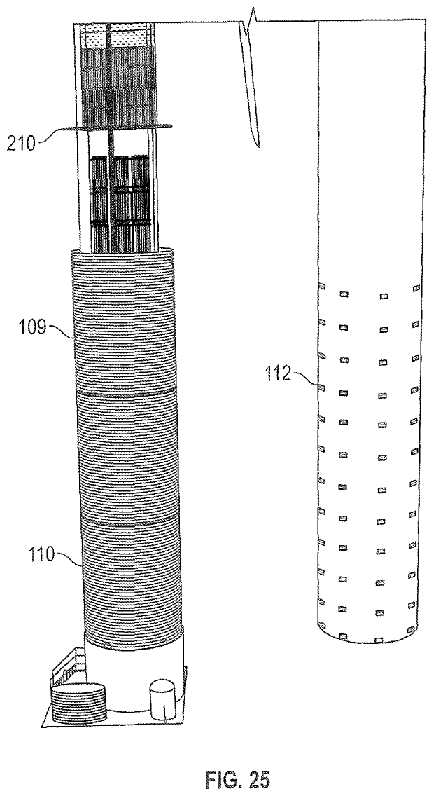

FIG. 25 shows the lower modified tower 101 section with components along with FRP interior 109 and the modified tower 101 cut out on the inside 112 and set aside for illustration purposes.

The ZEUS Generator provides a paradigm shift to autonomous wind energy, with the ability to de-couple from the Utility and the congested transmission system that limits the amount of renewable energy supply to electric users worldwide.

Transmission of electricity across the country is inadequate, congested, antiquated, and limits the ability for large amounts of renewable energy into the fuel mix available to energy suppliers. The ZEUS ZGen turbine will remove the transmission interconnect requirement that limits renewable energy penetration into the electricity and transportation markets. The ZEUS autonomous turbine will open new power off-taker markets which are not available to today's wind industry energy developments. “Green” ZGas created by the ZEUS turbine will allow the U.S. to achieve climate change net zero expectations.

The stored ZGas has ability to establish new wireless (without transmission interconnect) energy markets with direct sales of ZGas to existing industry and commercial hydrogen gas users. For those new emerging independent energy and wireless electricity customers the use of the ZGen get them to Net Zero and the ability to meet climate change commitments. This new RHGas fuel product created from wind energy allows the massive development of stranded and new wind energy development, decoupled from traditional utility costs, restrictions, RFPs and transmission congestion and limitations. The ZGen is capable of selling “firm”, “scheduled”, “peak and super-peak” electricity created by the included AC fuel cell component. The ZGas fuel can be shipped via FRP pipeline, tube trailer, the rail using ZGas tanker cars, or even commercial transport by dirigibles, directly to the various renewable gas and electricity customer market. The whole process is created and completed within, the first of its kind, fully integrated and multi-component equipped wind turbine tower and foundation dedicated to producing, storing, and exporting ZGas made from wind energy and water.

A value proposition; overall technical impact and economic benefits delivered: There are several major unique proprietary IP and IT roles and functions between the interaction of the various components to this concept of integrated renewable hydrogen generation producing (ZGas) by wind energy and stored in FRP piping. Benefits include (1); for wind energy, instead of competitively bidding and selling “as available” wind power electricity to utilities only, providing one market, and a very congested and competitive one at that; the ZGen would make a whole new product, Green ZGas, and open much larger and diverse markets. (2); you get ZGas as a storage mechanism with FRP pipe storage containment built into the tower and foundation, where there is plenty of room to store the ZGas. (3); is the opportunity to enter the near future Renewable Transportation Fuel (RTF) market, with ZGen turbines strategically placed for distribution and delivery via piped or vehicle transport, including ZGas filled dirigibles transported to commercial stations and industrial fuel cell customers directly and independent from utilities. (4); the ZGas product comes with a multi-year fixed price, potentially with the lowest price renewable energy on the market and is environmentally beneficial. (5); ZGeneration will be more efficient using DC to DC components and removing the need for inversion or rectifying. (6); by fixing the long-term price for ZGas you fix the price of ammonia, which fixes the price of fertilizer, which could ultimately fix the long-term price of food.

The induction generators used in most large grid-connected turbines require a small amount of continuous electricity from the grid to actively energize the magnetic coils (called field coils) around the asynchronous “cage rotor” that encloses the generator shaft; at the rated wind speeds, it helps keep the rotor speed constant, and as the wind starts blowing it helps start the rotor turning; in the rated wind speeds, the stator may use power equal to 10% of the turbine's rated capacity, in slower winds possibly much more.

Electromagnet generator wind turbines will draw current to start spinning. The generator works in reverse just like a motor. This feature is why wind turbines require utility inter-connect. Also, because the blades nowadays are too big and too heavy to start alone. Once the device that measures wind speed (anemometers) detects that the wind is at a certain minimum speed, the wind turbines draw energy from the grid to start spinning until reaching a minimum speed to spin by wind alone (going from mechanical to aerodynamics). A start-up fuel cell will provide the power to supply the electricity for startup protocols for the wind turbine. There will be a hydrogen generation loop to feed the electricity from the start-up fuel cell to be continuously available especially during turbine startup and low fluctuating wind conditions.

A conventional grid-connected wind turbine connected to a battery must send its generated electricity to the grid or to charge the battery, so only power after the grid demand and battery charging demand have been met is available to be used to start the wind turbine. However, because wind fluctuates often, in and out of the operating range of wind speeds (the range of wind speeds that will drive the rotor to rotate at a rotor rotation rate within the preferred range of rotor rotation rates, and thereby drive the generator shaft to rotate at shaft rotation rates within a generating range of shaft rotation rates to generate electricity), the generator may not generate electricity constantly, and therefore the generator may need to be started and stopped multiple times per hour. By contrast, in the present invention, all of the hydrogen generated is potentially available to power the start-up fuel cell, because none is sent to the grid or used to charge batteries. Thus, the start-up fuel cell can start and re-start the invention for as long as there is hydrogen in the invention's storage, instead of being restricted to a battery capacity that is far less because most of the generated electricity has been sent to the grid. Accordingly, the generator of this invention is self-powered by the start-up fuel cell, and the generator can be powered as long as the start-up fuel cell receives hydrogen from the storage (which hydrogen has been created by the electrolyzers using electricity generated by the generator), to create a virtuous cycle.

Also, because the present invention generates hydrogen and is decoupled from the grid, there is no requirement to curtail hydrogen production if wind speed is high, but grid demand is low. This happens very often because, for example, grid demand at night is low, but wind speed does not depend on day or night. By contrast, with a grid-coupled conventional wind turbine generating electricity and connected to a battery, if the wind speeds are high enough, or the grid demand is low enough, that the wind turbine is generating more electricity than demanded by the grid, and the batteries are fully charged, then the rotor must be “feathered”, that is, the pitch must be changed to slow rotation of the rotor and to reduce electricity generation, and electricity production curtailed, because there is no place to send any more generated electricity. With the present invention, until the hydrogen storage has been completed filled, the rotor can rotate at optimum rotation rates to generate the maximum amount of hydrogen.

Further, if a wind turbine is used only to charge batteries, without being connected to a utility grid, the charged batteries still must be connected to a utility grid in order to provide power when and where needed. This would require transportation of the batteries themselves, a very expensive proposition, or building transmission lines to the batteries. It is much easier and cheaper to transport hydrogen.

We will quickly approach the technology and operational circumstances with our ZGen that will produce a ZGas kilogram cheaper than a natural gas made kilogram, especially when you include the costs of environmental and political externalities. By utilizing ZGen energy, multiple new markets are opened for ZGas instead of just selling to one market, the Utilities.

This patent application provides a detailed description of the innovation and how it is significantly differentiated from current technologies or practices. Creating new renewable energy sources of Green Money from relatively free wind and water.

It is important to acknowledge that the technologies combined in this wind ZGen hybrid system haven't been combined and integrated in an autonomous and vertically designed to fit in a wind turbine tower and utilized to specifically produce RHGas instead of electricity to utilities via transmission and to be stored and exported from the base of a typical modern utility size wind turbine. In this case we are proposing 3 MW wind Generator, 3 MW of electrolyzers in an approximately 280 ft tube tower, and up to 3 MWs of fuel cells. The size of the ZGen can be from 1 MW up to 10 MWs and as larger offshore wind turbines are developed ZGen can meet the largest sizes. The component design would increase proportionately to megawatt size.

Incorporated with the integration of all the ZGen components will be the programmable Supervisory Control and Data Acquisition system (SCADA) design to communicate and administer data system monitoring controls to facilitate and safely operate the whole system including the unique FRP pipe storing of the ZGas. Regardless, who the various component suppliers and manufacturers might be selected the design specifications data and control algorithms for controlling and operating the various components will be covered by the unique design proposed for the ZGen.

The foundation can also contain additional coiled FRP storage. The compressed ZGas will be exported directly to Green ZGas off-takers, direct to customer.

The uniqueness of the proposed ZGen is based on the concept of taking ““as available” wind energy and making it “scheduled” or “Base Load” thus more valuable energy, at the turbine, by creating and storing ZGas on site within this specifically designed, de-coupled from utility transmission, wind turbine tower and foundation.

ZGas is a great storage compound, and can be stored pressurized, cryogenically, or in hydrides which allows larger and more versatile ZGas storage. Our intention is to store pressurized renewable ZGas in designed 6.5″ coiled FRP pipe on the interior or exterior of the modified 80 m+ tube tower, including additional storage in the foundation.

Most commercial and industrial energy users are potential off-takers including refineries, ammonia production facilities, metals and chemicals processes, heavy industries, commercial businesses, military bases, housing projects, and computer server farms, on a firm demand schedule.

This is the future of power to gas to power and the beginning of the end of climate changes greatest antagonist, fossil fuel pollution.

The de-coupled ZGen in a preferred embodiment is designed in a simplified DC-to-DC format. with no inversion or rectifying making it more energy efficient, between the wind turbine generator and the electrolyzers. ZGen can also be operated with or AC wind generation to AC electrolyzer. This removes the traditional required control components for utility interconnect including substations, and transmission access and costly annual reservation charges. The ZGen includes a fuel cell for turbine start-up and supplying electric sales to off-takers. This will revolutionize the single wind energy market by competing with coal and natural gas with wind generated ZGas. ZGas has more versatility and will establish multiple new markets for wind energy to ZGas. ZGen being autonomous will remove costly risk from weather and fire damage to and from overloaded transmission lines.

As oil peaks in the next 10 years, and renewable energy looks toward large long-term storage, ZGas produced from this autonomously and fully integrated exclusively designed for Green ZGas production will be the leader entering those markets. To supply a renewable energy future, without the effects of hydrocarbons from fossil fuels, or the creation of political and environmental distress and instability that create volatility in supply and price security is the goal of the ZEUS ZGas Generator.

The key technical objective is the unique specified design engineering of the ZGen and the inter-connection of the various technology components to work together seamlessly and efficiently to produce all renewable energy, Power to Gas to Power. There are several engineering disciplines involved in the integrated design process including, structural, chemical, industrial, electrical, and computer software. All need to be organized and managed to be able to communicate the subtleties, of science and safety of the design requirements to complete a ready to build operational design.

There are several high technological features in this patent, including the following:

The distinct, fully integrated platform, a method and apparatus for generating and producing RHGas (ZGas), by decoupling from the utility. Not so obvious to run DC2DC2AC or ZGen can utilize AC2AC2DC electrolyzers. Contrary to the state of wind technology today being wind generated electricity transmitted via distribution lines as AC to AC rectified to remote DC electrolyzer and generate RHGas. Having no utility interconnect, by itself is “contrary to conventional wisdom” and existing electric energy processes and conventions.

Fiberglass Reinforced Polymer (FRP) pipe coiled around the interior or exterior of the tower for the onboard storage of ZGas. The ZGas Storage System (ZGSS). After on board electrolysis the ZGas is compressed and pressurized and connected to the ZGSS for holding until direct use in fuel cell or distributed to markets.

Vertical stacked components including: electrolyzers, compressors, cooling or heat recovery systems, and power controls all mounted within a wind turbine tower.

As conceived, the ZEUS ZGen will require a necessary electric excitation since it has no utility inter-connect. The ZGen will use a start-up fuel cell to start and maintain operation of the generator. Typical wind turbines require power from the utility, to start the wind turbine generator. The ZGen will not require utility connection. Instead, power will come from the included start-up fuel cell specifically dedicated for initial turbine startup and active generation power control. This feature would never exist without the decoupling component of the ZGen.

Includes incorporating additional stacked FRP pipe coils up the tower and/or in the foundation and ground for additional storage if needed.

The ZEUS turbine provides full integration allowing stand-alone, “firm power from wind”, at the turbine site, deliverable via multiple methods; and include the wind turbine now providing electricity and transportation fuel, with zero emissions.

ZEUS generation will create long term fixed price Least Cost OF Energy (LCOE) “Green” hydrogen (ZGas.

ZGen design with the integration of all the ZGen components will be the programmable Supervisory Control and Data Acquisition (SCADA) system designed to communicate and administer data system monitoring and recording controls to facilitate and safely operate the whole system including the unique FRP pipe storing of the ZGas.

The objective and anticipated result of the invention, the Zero emissions U.S. (ZEUS) Renewable Hydrogen Wind Generator (ZGen), is to create least cost “Green” Renewable Hydrogen Gas (ZGas). The vertical integration of the ZGen components is non-obvious and it will achieve technological results that are unpredictably better than would be expected from the typical industry standard for RHGas utilizing the combination of its components. For this application we will be using a 3 MW wind turbine on 80 m tubular tower.

While the present invention has been disclosed in connection with the presently preferred embodiments disclosed herein, it will be obvious to those ordinarily skilled in the art that there are other embodiments that fall within the spirit and scope of the invention, as defined by the claims. Accordingly, no limitations are to be implied or inferred in the scope of this patent, except as specifically and explicitly set forth in the claims.

### INDUSTRIAL APPLICABILITY

This invention is applicable whenever and wherever there is a need for energy at an economic price and wind is available, regardless of the availability of electrical transmission lines or connection to an electric grid.

What is claimed is:

1. A wind powered hydrogen generator with storage that is decoupled from an electric grid, comprising:
a tower;
a nacelle yawably mounted on said tower;
a generator having field coils that must be energized to generate electricity, and a rotatable shaft, inside said nacelle, decoupled from said electric grid, wherein said generator generates electricity when said field coils are energized and said shaft is driven to rotate at shaft rotation rates that are within a generating range of shaft rotation rates;
a rotor having a hub and blades with an adjustable pitch mounted on said hub, said rotor being drivably connected to said shaft, whereby said rotor rotatably drives said shaft,
whereby when said blades are adjusted to be at desired pitches and said nacelle yaws so said rotor faces substantially into the wind, and the wind is in an operating range of wind speed, the wind drives the rotor to rotate at rotor rotation rates within a desired range of rotor rotation rates, which drives said shaft to rotate at shaft rotation rates within said generating range of shaft rotation rates, which drives said generator to generate electricity;
a yawing motor connected to said nacelle to yaw said nacelle to cause said rotor to face substantially into the wind;
a start-up fuel cell decoupled from said electrical grid, electrically connected to said generator, said pitch adjustable blades and said yawing motor, wherein said start-up fuel cell provides power to said generator to energize said field coils, to said pitch adjustable blades to adjust pitch of said blades to maintain rotor rotation rates of said rotor within said desired range of rotor rotation rates, and to power said yawing motor to cause said rotor to face substantially into the wind;
electrolyzers mounted in said tower electrically connected to said generator to generate hydrogen from said electricity generated by said generator; and
hydrogen impermeable piping connected to said electrolyzers and also to said start-up fuel cell, mounted on said tower, to receive said generated hydrogen for storage and also to provide said generated hydrogen to said start-up fuel cell;
whereby said start-up fuel cell can be refueled from said generated hydrogen in said impermeable piping as needed;
whereby said wind powered hydrogen generator can be sited in locations having wind speeds within said operating range of wind speeds, regardless of whether said generator, said yawing motor and said blades are connected to said electric grid;
whereby hydrogen stored in said piping can be used or transported as and when needed, even when wind speed may be outside said operating range so that said generator does not generate electricity;
whereby intermittent power of wind in locations decoupled from electric grids is converted to firm energy.

2. A wind powered hydrogen generator, according to claim 1, wherein said piping is mounted on said tower by being coiled on the exterior of said tower.

3. A wind powered hydrogen generator, according to claim 1, wherein said piping is mounted on said tower by being coiled on the interior surface of said tower.

4. A wind powered hydrogen generator, according to claim 1, wherein said piping comprises fiber reinforced polymer piping.

5. A wind powered hydrogen generator, according to claim 1, wherein said rotor is drivably connected to said shaft by a gearbox that drives said shaft at shaft rotation rates within said generating rage of shaft rotation rates when said rotor rotates at rotor rotation rates within said desired range of rotor rotation rates.

6. A wind powered hydrogen generator with storage that is decoupled from an electric grid, comprising:
a tower;
a nacelle yawably mounted on said tower;
a generator having a rotatable shaft inside said nacelle, decoupled from said electric grid, wherein said generator generates electricity when said shaft is driven to rotate at shaft rotation rates that are within a generating range of shaft rotation rates;
a rotor having a hub and blades with an adjustable pitch mounted on said hub, said rotor being drivably connected to said shaft, whereby said rotor rotatably drives said shaft,
whereby when said blades are adjusted to be at desired pitches and said nacelle yaws so said rotor faces substantially into the wind, and the wind is in an operating range of wind speed, the wind drives the rotor to rotate at rotor rotation rates within a desired range of rotor rotation rates, which drives said shaft to rotate at shaft rotation rates within said generating range of shaft rotation rates, which drives said generator to generate electricity;
a yawing motor connected to said nacelle to yaw said nacelle to cause said rotor to face substantially into the wind;
a start-up fuel cell decoupled from said electrical grid, electrically connected to said pitch adjustable blades and said yawing motor, wherein said start-up fuel cell provides power to said pitch adjustable blades to adjust pitch of said blades to maintain rotation rates of said rotor within said range of rotor rotation rates, and to power said yawing motor to cause said rotor to face substantially into the wind;
electrolyzers mounted in said tower electrically connected to said generator to generate hydrogen from said electricity generated by said generator; and
hydrogen impermeable piping connected to said electrolyzers and also to said start-up fuel cell, mounted on said tower, to receive said generated hydrogen for storage and also to provide said generated hydrogen to said start-up fuel cell;
whereby said start-up fuel cell can be refueled from said generated hydrogen in said impermeable piping as needed;
whereby said wind powered hydrogen generator can be sited in locations having wind speeds within said operating range of wind speeds, regardless of whether said yawing motor and said blades can be connected to said electric grid;
whereby hydrogen stored in said piping can be used or transported as and when needed, even when wind speed may be outside said operating range so that said generator does not generate electricity;
whereby intermittent power of wind in locations decoupled from electric grids is converted to firm energy.
